(19) United States
(12) Patent Application Publication
(10) Pub. No.: US 2015/0287386 A1
(43) Pub. Date: Oct. 8, 2015

(54) IMAGE DISPLAY APPARATUS AND OPERATION METHOD THEREOF

(71) Applicant: LG ELECTRONICS INC., Seoul (KR)

(72) Inventor: Hyungoon KIM, Seoul (KR)

(73) Assignee: LG Electronics Inc.

(21) Appl. No.: 14/663,784

(22) Filed: Mar. 20, 2015

(30) Foreign Application Priority Data
Apr. 7, 2014 (KR) 10-2014-0041391

(51) Int. Cl. G09G 5/10; G09G 5/18; H05B 37/02

(52) U.S. Cl. CPC G09G 5/10; H05B 37/0281; G09G 5/18; G09G 2330/021

(57) ABSTRACT

An image display apparatus may include a panel, a backlight lamp to output light to the panel, and a drive controller to control current flowing in the backlight lamp. When a level of the current flowing in the backlight lamp during a first period is a first level, the drive controller controls the level of the current flowing in the backlight lamp during a second period (after the first period) to be a second level. A deviation of power consumption may be reduced.

### CROSS-REFERENCE TO RELATED APPLICATION

This application claims priority under 35 U.S.C. §119 to Korean Application No. 10-2014-0041391, filed Apr. 7, 2014, the subject matter of which is hereby incorporated by reference.

### BACKGROUND

1. Field

Embodiments may relate to an image display apparatus and an operation method thereof. More particularly, embodiments may relate to an image display apparatus that is capable of reducing a deviation of power consumption and an operation method thereof.

2. Background

Digital broadcasting may refer to broadcasting to transmit digital video and audio signals. The digital broadcasting may exhibit low data loss due to robustness against external noise, excellent error correction, high resolution, and high definition as compared with analog broadcasting. The digital broadcasting can provide a bidirectional service unlike the analog broadcasting.

The resolution of an image display apparatus has been increased in response to a request of users who wish to view a high-definition image. As a result, an image display apparatus with increased resolution has been developed. However, power consumption of the image display apparatus may be increased due to increase of the resolution.

### SUMMARY OF THE INVENTION

Embodiments may provide an image display apparatus that is capable of reducing a deviation of power consumption and an operation method thereof.

Embodiments may provide an image display apparatus including a panel, a backlight lamp to output light to the panel, and a drive controller to control current flowing in the backlight lamp. When a level of the current flowing in the backlight lamp during a first period is a first level, the drive controller may control the level of the current flowing in the backlight lamp during a second period (after the first period) to be a second level.

Embodiments may provide an image display apparatus including a panel, a backlight lamp to output light to the panel, and a drive controller to control current flowing in the backlight lamp. The drive controller may control a level of the current flowing in the backlight lamp during a second period (after a first period) based on an average level of voltage applied to the backlight lamp during the first period.

An operation method of an image display apparatus may include detecting voltage applied to a backlight lamp, detecting current flowing in the backlight lamp, calculating power consumption based on the detected voltage and current, calculating a current compensation value based on the calculated power consumption and target power consumption, and driving the backlight lamp based on the calculated current compensation value.

### BRIEF DESCRIPTION OF THE DRAWINGS

Embodiments may be described in detail with reference to the following drawings in which like reference numerals refer to like elements and wherein:

FIG. 1 is a view showing an external appearance of an image display apparatus according to an embodiment;

FIG. 2 is an internal block diagram of an image display apparatus according to an embodiment;

FIG. 3 is an internal block diagram of a controller (of FIG. 2);

FIG. 4 is a view showing a control method of a remote controller (of FIG. 2);

FIG. 5 is an internal block diagram of the remote controller (of FIG. 2);

FIG. 6 is a view showing an example of a power supply unit and an interior of a display (of FIG. 2);

FIGS. 7A to 7C are views illustrating various arrangement examples of backlight lamps (of FIG. 6);

FIG. 8 is a flowchart showing an operation method of an image display apparatus according to an embodiment;

FIGS. 9 and 10 are reference views illustrating an operation method (of FIG. 8);

FIG. 11 is a view showing an example of a partial circuit of an image display apparatus according to an embodiment;

FIG. 12 is a view showing an example of voltage and current waveforms applied to backlight lamps according to an embodiment;

FIGS. 13 and 14 are views showing various examples of a transition period of FIG. 12, which is partially enlarged;

FIG. 15 is a view showing an example of voltage and current waveforms applied to backlight lamps according to an embodiment;

FIG. 16 is a view showing an example of a transition period of FIG. 15, which is partially enlarged;

FIG. 17 is a view showing an example of voltage and current waveforms applied to backlight lamps according to an embodiment; and

FIG. 18 is a graph showing distribution of power consumption.

### DETAILED DESCRIPTION

Reference may now be made in detail to preferred embodiments, examples of which are illustrated in the accompanying drawings.

The terms “module” and “unit,” when attached to names of components are used herein to help understanding of the components and thus they should not be considered as having specific meanings or roles. Accordingly, the terms “module” and “unit” may be used interchangeably.

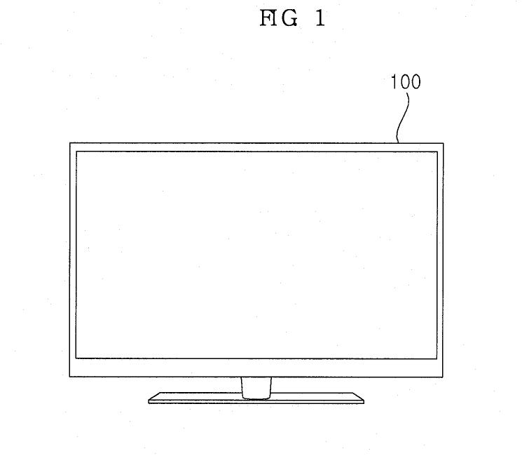

FIG. 1 is a view showing an external appearance of an image display apparatus according to an embodiment. Other embodiments and configurations may also be provided.

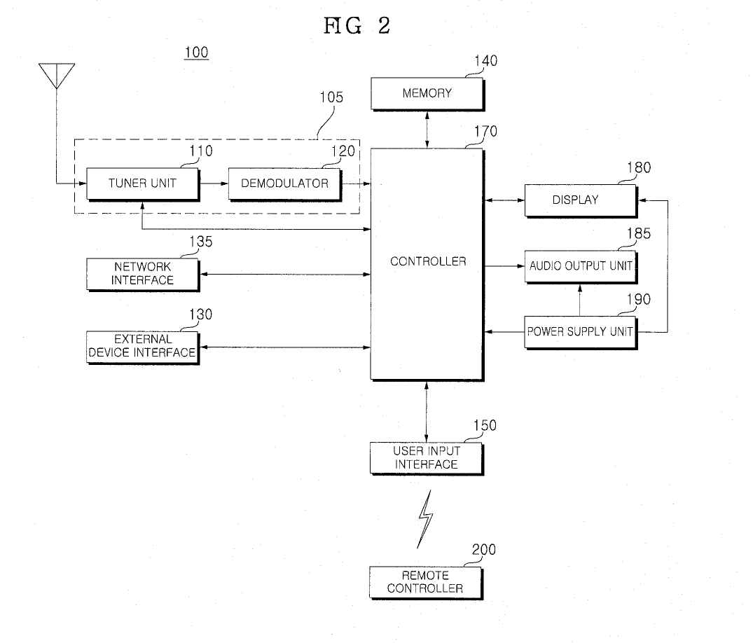

FIG. 1 shows an image display apparatus 100 that may include a display 180 (FIG. 2), a controller 170 (FIG. 2) to control an image to be displayed on the display 180, and a power supply unit 190 (FIG. 2) to supply power to the display 180.

As resolution of the image display apparatus 100 is increased to High Definition (HD), Full HD, and Ultra High Definition (UHD), on the other hand, power consumption of the image display apparatus 100 may increase. For this reason, various methods of reducing power consumption have been studied.

Embodiments may provide a method of reducing a deviation of power consumption of the image display apparatus.

When the display 180 includes a liquid crystal panel, an additional backlight lamp may be used.

The backlight lamp may consume about 60 to 70% of power used by the image display apparatus 100. As resolution of the image display apparatus 100 is increased to High Definition (HD), Full HD, Ultra High Definition (UHD), 4K, 8K, etc., an LED drive voltage Vf and/or LED drive current If of the backlight lamp may increase. As the LED drive voltage Vf or the LED drive current If is increased, power consumption of the backlight lamp may increase. For this reason, embodiments may provide a method of reducing a deviation of power consumption of the backlight lamp while reducing power consumption of the backlight lamp.

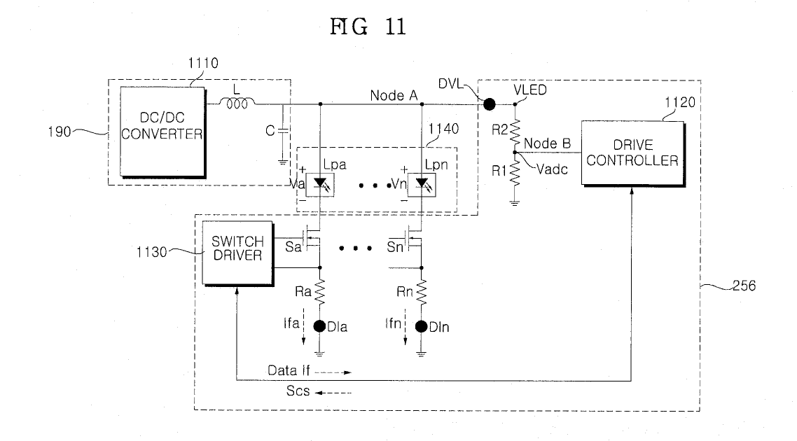

More specifically, when a level of current flowing in a backlight lamp 1140 (FIG. 11) during a first period is a first level, a drive controller 1120 (FIG. 11) to control current flowing in the backlight lamp 1140 may control the level of current flowing in the backlight lamp 1140 during a second period (after the first period) to be a second level.

The drive controller 1120 (FIG. 11) may calculate (or determine) power consumption based on voltage applied to the backlight lamp and current flowing in the backlight lamp, and the drive controller may control current flowing in the backlight lamp during the second period to have the second level based on the calculated power consumption and a target power consumption.

When the power consumption based on the current flowing in the backlight lamp during the first period is higher than the target power consumption, the drive controller 1120 may control the second level to be lower than the first level.

On the other hand, when the power consumption based on the current flowing in the backlight lamp during the first period is lower than the target power consumption, the drive controller 1120 may control the second level to be higher than the first level.

The drive controller 1120 may control the level of the current flowing in the backlight lamp to be sequentially changed from the first level to the second level during a transition period between the first period and the second period.

On the other hand, the drive controller 1120 may calculate (or determined) a current compensation value to compensate for the current flowing in the backlight lamp based on the calculated power consumption and the target power consumption, and control the current flowing in the backlight lamp during the second period to have the second level based on the current compensation value.

When the voltage applied to the backlight lamp is changed, the drive controller 1120 may control the current flowing in the backlight lamp to follow the target power consumption (or to substantially correspond to the target power consumption).

On the other hand, when the voltage applied to the backlight lamp during the first period is lower than the target voltage, the drive controller 1120 may control the level of the current flowing in the backlight lamp during the second period (after the first period) to be higher than the level of the current flowing in the backlight lamp during the first period.

Operation of the drive controller to control driving of the backlight lamp to reduce a deviation of power consumption of the image display apparatus may be described with reference to FIG. 11.

FIG. 2 is an internal block diagram of an image display apparatus according to an embodiment. Other embodiments and configurations may also be provided.

FIG. 2 shows the image display apparatus 100 may include a broadcast reception unit 105, an external device interface 130, a network interface 135, a memory 140, a user input interface 150, a sensor unit, a controller 170, a display 180, and an audio output unit 185.

The broadcast reception unit 105 may include a tuner unit 110 and a demodulator 120. The broadcast reception unit 105 may further include the network interface 135. The broadcast reception unit 105 may be designed to include the tuner unit 110 and the demodulator 120, but not to include the network interface 135. On the other hand, the broadcast reception unit 105 may be designed to include the network interface 135, but not to include the tuner unit 110 and the demodulator 120.

The broadcast reception unit 105 may further include the external device interface 130 unlike the drawing. For example, a broadcast signal from a settop box may be received through the external device interface 130.

The tuner unit 110 may tune to a radio frequency (RF) broadcast signal corresponding to a channel selected by a user from among RF broadcast signals received by an antenna or all prestored channels. The tuner unit 110 may convert the tuned RF broadcast signal into an intermediate frequency (IF) signal or a baseband video or audio signal.

For example, when the tuned RF broadcast signal is a digital broadcast signal, the tuner unit 110 may convert the tuned RF broadcast signal into a digital IF signal (DIF). On the other hand, when the tuned RF broadcast signal is an analog broadcast signal, the tuner unit 110 may convert the tuned RF broadcast signal into an analog baseband video or audio signal (CVBS/SIF). That is, the tuner unit 110 may process a digital broadcast signal or an analog broadcast signal. The analog baseband video or audio signal (CVBS/SIF) output from the tuner unit 110 may be directly input to the controller 170.

Additionally, the tuner unit 110 may sequentially tune to RF broadcast signals of all broadcast channels stored through a channel memory function from among RF broadcast signals received by the antenna and convert the tuned RF broadcast signals into intermediate frequency signals or baseband video or audio signals.

The tuner unit 110 may include a plurality of tuners to receive broadcast signals of a plurality of channels. Alternatively, the tuner unit 110 may include a single tuner to simultaneously receive broadcast signals of a plurality of channels.

The demodulator 120 may receive the digital IF signal (DIF) converted by the tuner unit 110 and perform demodulation.

After performing the demodulation and channel decoding, the demodulator 120 may output a transport stream signal (TS). The transport stream signal may be a multiplexed video signal, a multiplexed audio signal, and/or a multiplexed data signal.

The transport stream signal output from the demodulator 120 may be input to the controller 170. The controller 170 may perform demultiplexing, video/audio signal processing, etc. Subsequently, the controller 170 may output a video to the display 180 and output an audio to the audio output unit 185.

The external device interface 130 may transmit or receive data to or from an external device connected to the image display apparatus 100. The external device interface 130 may include an audio/video (A/V) input and output unit or a wireless communication unit.

The external device interface 130 may be connected to an external device, such as a digital versatile disc (DVD) player, a Blu-ray player, a game console, a camera, a camcorder, a computer (a laptop computer), or a settop box, in a wired/wireless fashion. Additionally, the external device interface 130 may perform an input operation to the external device or an output operation from the external device.

The A/V input and output unit may receive a video signal and an audio signal from the external device. The wireless communication unit may perform a near field communication with another electronic device.

The network interface 135 may provide an interface to connect the image display apparatus 100 to a wired/wireless network including the Internet. For example, the network interface 135 may receive content or data provided by a content provider or a network operator over a network, such as the Internet.

The memory 140 may store a program to process and control signals in the controller 170. Alternatively, the memory 140 may store a processed video, audio, or data signal.

Additionally, the memory 140 may temporarily store a video, audio, or data signal input to the external device interface 130. The memory 140 may store information regarding a predetermined broadcast channel using a channel memory function, such as a channel map.

In FIG. 2, the memory 140 may be provided separately from the controller 170. However, embodiments are not limited thereto. For example, the memory 140 may be included in the controller 170.

The user input interface 150 may transfer a signal input by a user to the controller 170 or transfer a signal from the controller 170 to the user.

For example, the user input interface 150 may transmit/receive a user input signal, such as power on/off, channel selection, or screen setting, to/from a remote controller 200. The user input interface 150 may transfer a user input signal input through a local key, such as a power key, a channel key, a volume key, or a setting key, to the controller 170. Additionally, the user input interface 150 may transfer a user input signal input from a sensor unit to sense a gesture of a user to the controller 170 or transmit a signal from the controller 170 to the sensor unit.

The controller 170 may demultiplex a stream input through the tuner unit 110, the demodulator 120, or the external device interface 130 or process demultiplexed signals to generate and output a video or audio signal.

The video signal processed by the controller 170 may be input to the display 180, which may display a video corresponding to the video signal. Additionally, the video signal processed by the controller 170 may be input to an external output device through the external device interface 130.

The audio signal processed by the controller 170 may be output to the audio output unit 185. Additionally, the audio signal processed by the controller 170 may be input to the external output device through the external device interface 130.

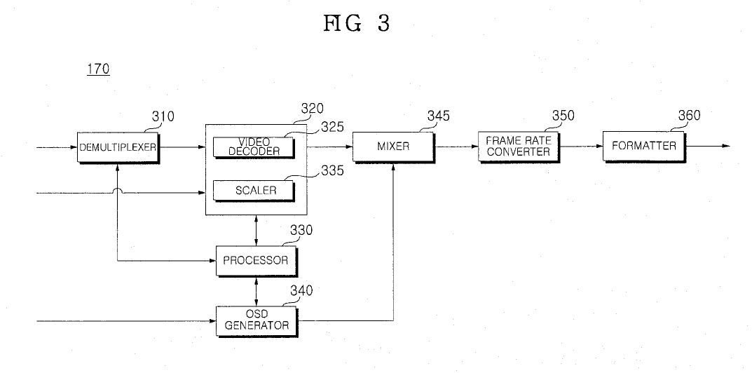

The controller 170 may include a demultiplexer and an image processing unit, which may be described with reference to FIG. 3.

On the other hand, the controller 170 may control overall operation of the image display apparatus 100. For example, the controller 170 may control the tuner unit 110 to tune to a channel selected by a user or an RF broadcast corresponding to a prestored channel.

Additionally, the controller 170 may control the image display apparatus 100 based on a user command input through the user input interface 150 or an internal program.

On the other hand, the controller 170 may control the display 180 to display an image. The image displayed on the display 180 may be a still picture or a motion picture. Alternatively, the image displayed on the display 180 may be a two-dimensional (2D) image or a three-dimensional (3D) image.

The controller 170 may generate and display a 2D object in the image displayed on the display 180 as a 3D object. For example, the object may be at least one selected from among an accessed web page (a newspaper, a magazine, etc.), an electronic program guide (EPG), a variety of menus, a widget, an icon, a still picture, a motion picture, and/or text.

The 3D object may be processed to have a depth different from the depth of the image displayed on the display 180. For example, the 3D object may be processed to protrude more than the image displayed on the display 180.

The controller 170 may recognize a location of a user based on an image captured by an image capturing unit. For example, the controller 170 may recognize a distance (z-axis coordinate) between the user and the image display apparatus 100. Additionally, the controller 170 may recognize an x-axis coordinate and a y-axis coordinate in the display 180 corresponding to the location of the user.

The image display apparatus 100 may further include a channel browsing processing unit to generate a thumbnail image corresponding to a channel signal or an externally input signal. The channel browsing processing unit may receive a transport stream signal (TS) output from the demodulator 120 or a transport stream signal output from the external device interface 130 and extract an image from the received transport stream signal to generate a thumbnail image. The generated thumbnail image may be stream-decoded together with the decoded image and then input to the controller 170. The controller 170 may control a thumbnail list including a plurality of thumbnail images to be displayed on the display 180 using the input thumbnail image.

The thumbnail list may be displayed in a simple view mode in which a portion of the thumbnail list is displayed in a state in which a predetermined image is displayed on the display 180 or in a full view mode in which the thumbnail list is displayed on the most part of the display 180. The thumbnail images of the thumbnail list may be sequentially updated.

The display 180 may covert an image signal, a data signal, an on-screen display (OSD) signal, or a control signal processed by the controller 170 or an image signal, a data signal, or a control signal received from the external device interface 130 into a drive signal.

A plasma display panel (PDP), a liquid crystal display (LCD), an organic light emitting diode (OLED) display, and/or a flexible display may be used as the display 180. The display 180 may have a 3D display function.

The display 180 may display a 3D image in an additional display mode or in a single display mode such that a user can view the 3D image.

In the single display mode, the display 180 may realize a 3D image without an additional display, such as glasses. For example, the single display mode may include various modes, such as a lenticular mode and a parallax barrier mode.

On the other hand, in the additional display mode, an additional display may be used as a viewing apparatus in addition to the display 180 in order to realize a 3D image. For example, the additional display mode may include various modes, such as a head mounted display (HMD) mode and a glasses mode.

The glasses mode may be classified into a passive mode, such as a polarized glasses mode, and an active mode, such as a shutter glasses mode. Additionally, the head mounted display mode may be classified into a passive mode and an active mode.

The viewing apparatus may be 3D glasses that enable a user to view a stereoscopic image. The 3D glasses may include passive type polarized glasses or active type shutter glasses. The 3D glasses may also include head mounted display type glasses.

On the other hand, a touchscreen may be used as the display 180. The display 180 may be used as an input device in addition to an output device.

The audio output unit 185 may receive an audio signal processed by the controller 170 and output the received audio signal in the form of an audible sound.

The image capturing unit may capture an image of a user. The image capturing unit may include one camera. However, embodiments are not limited thereto. For example, the image capturing unit may include a plurality of cameras. Meanwhile, the image capturing unit may be embedded in the image display apparatus 100 at the upper part of the display 180 or disposed separately from the image display apparatus 100. Image information captured by the image capturing unit may be input to the controller 170.

The controller 170 may sense a gesture of the user by using the image captured by the image capturing unit and/or the signal sensed by the sensing unit.

The power supply unit 190 may supply power to the display apparatus 100. More specifically, the power supply unit 190 may supply power to the controller 170, which may be realized in the form of a system on chip (SOC), the display 180 to display a video, and the audio output unit 185 to output an audio.

The power supply unit 190 may include a converter to convert alternating current power into direct current power and a DC/DC converter to convert the level of the direct current power.

The remote controller 200 may transmit a user input to the user input interface 150. The remote controller 200 may use various communication techniques such as Bluetooth communication, radio frequency (RF) communication, infrared (IR) communication, ultra wideband (UWB) communication, and/or ZigBee communication.

Additionally, the remote controller 200 may receive a video, audio, or data signal output from the user input interface 150 and display the received signal or output the received signal as a sound.

The image display apparatus 100 may be a fixed type or mobile type digital broadcast receiver that can receive digital broadcast.

FIG. 2 is a block diagram of the image display apparatus 100 (FIG. 2). Respective components of the block diagram may be combined, added, or omitted according to specifications of an image display apparatus 100. That is, two or more components may be combined into a single component or one component may be divided into two or more components as needed. Additionally, the function performed by each block is intended for description of the embodiment and actions or components of each block does not limit the scope of the embodiment.

On the other hand, the image display apparatus 100 may not include the tuner unit 110 and the demodulator 120 (FIG. 2) and may receive and reproduce image content through the network interface 135 or the external device interface 130.

The image display apparatus 100 may be an example of an image signal processing apparatus that processes an image stored in the apparatus or an input image. A settop box excluding the display 180 and the audio output unit 185 shown in FIG. 2, a DVD player, a Blu-ray player, a game console, and a computer may be used as other examples of the image signal processing apparatus.

FIG. 3 is an internal block diagram of the controller 170. Other embodiments and configurations may also be provided.

FIG. 3 shows the controller 170 may include a demultiplexer 310, a video processing unit 320, a processor 330, an OSD generator 340, a mixer 345, a frame rate converter 350, and a formatter 360. The controller 170 may further include an audio processing unit and a data processing unit.

The demultiplexer 310 may demultiplex an input stream. For example, when an MPEG-2 TS is input, the demultiplexer 310 may demultiplex the MPEG-2 TS into video, audio, and data signals. The transport stream signal input to the demultiplexer 310 may be a transport stream signal output from the tuner unit 110, the demodulator 120, or the external device interface 130.

The video processing unit 320 may process a demultiplexed video signal. The video processing unit 320 may include a video decoder 325 and a scaler 335.

The video decoder 325 may decode the demultiplexed video signal and the scaler 335 scales the resolution of the decoded video signal such that the video signal can be output to the display 180.

Decoders based on various standards may be used as the video decoder 325.

The video signal decoded by the video processing unit 320 may be classified as a 2D video signal, a 3D video signal, or a combination of the 2D video signal and the 3D video signal.

For example, an external video signal input from an external device or a video component of a broadcast signal received by the tuner unit 110 may be classified as a 2D video signal, a 3D video signal, or a combination of the 2D video signal and the 3D video signal. The external video signal input from the external device or the video component of the broadcast signal received by the tuner unit 110 may be processed by the controller 170, and more specifically the video processing unit 320 such that the external video signal input from the external device or the video component of the broadcast signal received by the tuner unit 110 can be output as a 2D video signal, a 3D video signal, or a combination of the 2D video signal and the 3D video signal.

On the other hand, the video signal decoded by the video processing unit 320 may be one of 3D video signals based on various formats. For example, the video signal decoded by the video processing unit 320 may be a 3D video signal including a color image and a depth image. Alternatively, the video signal decoded by the video processing unit 320 may be a 3D video signal including a multi-view video signal. For example, the multi-view video signal may include a left-eye video signal and a right-eye video signal.

The formats of the 3D video signal may include a side by side format at which the left-eye video signal L and the right-eye video signal R are arranged side by side, a top and bottom format at which the left-eye video signal L and the right-eye video signal R are arranged at top and bottom, a frame sequential format at which the left-eye video signal L and the right-eye video signal R are arranged by time division, an interlaced format at which the left-eye video signal L and the right-eye video signal R are mixed per line, and a checker box format at which the left-eye video signal L and the right-eye video signal R are mixed per box.

The processor 330 may control overall operation of the image display apparatus 100 or the controller 170. For example, the processor 330 may control the tuner unit 110 to tune to a channel selected by a user or an RF broadcast corresponding to a prestored channel.

Additionally, the processor 330 may control the image display apparatus 100 based on a user command input through the user input interface 150 or an internal program.

The processor 330 may control transmission of data to the network interface 135 or the external device interface 130.

Additionally, the processor 330 may control operations of the demultiplexer 310, the video processing unit 320, and the OSD generator 340 (of the controller 170).

The OSD generator 340 may generate an OSD signal according to a user input or autonomously. For example, the OSD generator 340 may generate a signal to display various kinds of information on the screen of the display 180 in the form of graphics or text based on a user input signal. The generated OSD signal may include various data, such as a user interface screen, various menu screens, a widget, and an icon, of the image display apparatus 100. Additionally, the generated OSD signal may include a 2D object or a 3D object.

Additionally, the OSD generator 340 may generate a pointer that can be displayed on the display based on a pointing signal input from the remote controller 200. The pointer may be generated by a pointing signal processing unit. The OSD generator 340 may include a pointing signal processing unit. The pointing signal processing unit may not be provided in the OSD generator 340 but may be provided separately from the OSD generator 340.

The mixer 345 may mix the OSD signal generated by the OSD generator 340 with the decoded video signal processed by the video processing unit 320. At this time, the OSD signal and the decoded video signal may each include at least one selected from between a 2D signal and a 3D signal. The mixed video signal is provided to the frame rate converter 350.

The frame rate converter 350 may convert the frame rate of an input video. On the other hand, the frame rate converter 350 may directly output an input video without converting the frame rate of the input video.

The formatter 360 may arrange left-eye video frames and right-eye video frames of the 3D video, the frame rate of which has been converted. Additionally, the formatter 360 may output a synchronization signal Vsync to open a left-eye glasses part and a right-eye glasses part of a 3D viewing apparatus.

The formatter 360 may receive the signal mixed by the mixer 345 (i.e., the OSD signal and the decoded video signal), and separate the signal into a 2D video signal and a 3D video signal.

Additionally, the formatter 360 may change the format of a 3D video signal. For example, the formatter 360 may change the format of the 3D video signal into any one of the formats as previously described.

On the other hand, the formatter 360 may convert a 2D video signal into a 3D video signal. For example, the formatter 360 may detect an edge or a selectable object from a 2D video signal, separate an object based on the detected edge or the selectable object from the 2D video signal, and generate a 3D video signal based on the separated object according to a 3D video generation algorithm. The generated 3D video signal may be separated into a left-eye video signal L and a right-eye video signal R, which may be arranged, as previously described.

A 3D processor for 3D effect signal processing may be further disposed at the rear of the formatter 360. The 3D processor may control brightness, tint, and color of a video signal to improve a 3D effect. For example, the 3D processor may perform signal processing such that a short distance is vivid while a long distance is blurred. The function of the 3D processor may be incorporated in the formatter 360 or the video processing unit 320

The audio processing unit (of the controller 170) may process a demultiplexed audio signal. The audio processing unit may include various decoders.

The audio processing unit may adjust bass, treble, and volume of the audio signal.

The data processing unit (of the controller 170) may process a demultiplexed data signal. For example, when the demultiplexed data signal is an encoded data signal, the data processing unit may decode the demultiplexed data signal. The encoded data signal may be electronic program guide (EPG) information containing broadcast information, such as start time and end time, of a broadcast program provided by each channel.

In FIG. 3, the signals from the OSD generator 340 and the video processing unit 320 are mixed by the mixer 345 and then 3D processing is performed by the formatter 360. However, embodiments are not limited thereto. For example, the mixer may be disposed at the rear of the formatter. That is, the formatter 360 may 3D process output of the video processing unit 320, the OSD generator 340 may perform 3D processing together with OSD generation, and the mixer 345 may mix the 3D signals processed by the formatter 360 and the OSD generator 340.

FIG. 3 shows a block diagram of the controller 170. The respective components of the block diagram may be combined, added, or omitted according to specifications of a controller.

The frame rate converter 350 and the formatter 360 may not be provided in the controller 170, but may be provided separately from the controller 170 as one module.

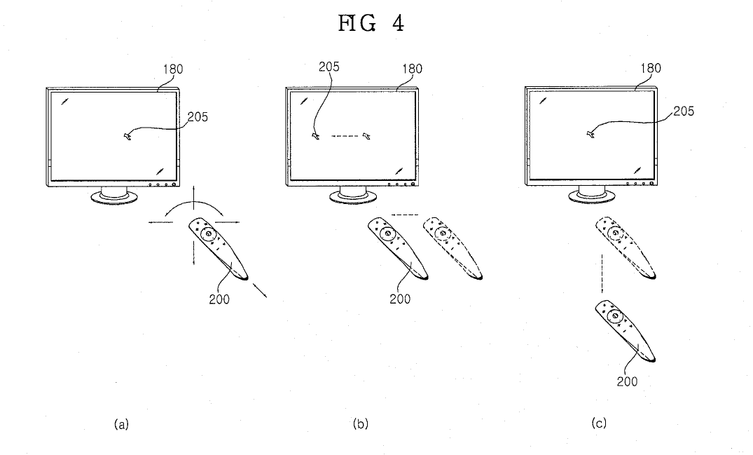

FIG. 4 is a view showing a control method of a remote controller (of FIG. 2). Other embodiments and configurations may also be provided.

As shown in FIG. 4(a), a pointer 205 corresponding to the remote controller 200 may be displayed on the display 180.

A user may move or rotate the remote controller 200 up and down, side to side (FIG. 4(b), and back and forth (FIG. 4(c)). The pointer 205 displayed on the display 180 corresponds to motion of the remote controller 200. Since the pointer 205 corresponding to the remote controller 200 is moved and displayed according to motion in a 3D space, the remote controller 200 may be referred to as a spatial remote controller or a 3D pointing apparatus.

FIG. 4(b) illustrates a case in which, when the user moves the remote controller 200 to the left, the pointer 205 moves to the left on the display 180 (of the image display apparatus).

Information regarding motion of the remote controller 200 sensed by a sensor of the remote controller is transmitted to the image display apparatus. The image display apparatus may calculate coordinates of the pointer 205 from the information regarding the motion of the remote controller 200. The image display apparatus may display the pointer 205 such that the pointer 205 corresponds to the calculated coordinates.

FIG. 4(c) illustrates a case in which the user moves the remote controller 200 away from the display 180 in a state in which the user pushes a predetermined button of the remote controller 200. As a result, a selected area in the display 180 corresponding to the pointer 205 may be zoomed in and thus displayed on the display 180 in an enlarged state. On the other hand, when the user moves the remote controller 200 toward the display 180, a selected area in the display 180 corresponding to the pointer 205 may be zoomed out and thus displayed on the display 180 in a reduced state. Alternatively, the selected area may be zoomed out when the remote controller 200 moves away from the display 180 and the selected area may be zoomed in when the remote controller 200 moves toward the display 180.

Up, down, left, and right movements of the remote controller 200 may not be recognized in a state in which a predetermined button of the remote controller 200 is pushed. That is, when the remote controller 200 moves away from or toward the display 180, the up, down, left, and right movements of the remote controller 200 may not be recognized and only back and forth movements of the remote controller 200 may be recognized. In a state in which a predetermined button of the remote controller 200 is not pushed, only the pointer 205 moves in accordance with the up, down, left or right movement of the remote controller 200.

The movement speed or the movement direction of the pointer 205 may correspond to the movement speed or the movement direction of the remote controller 200.

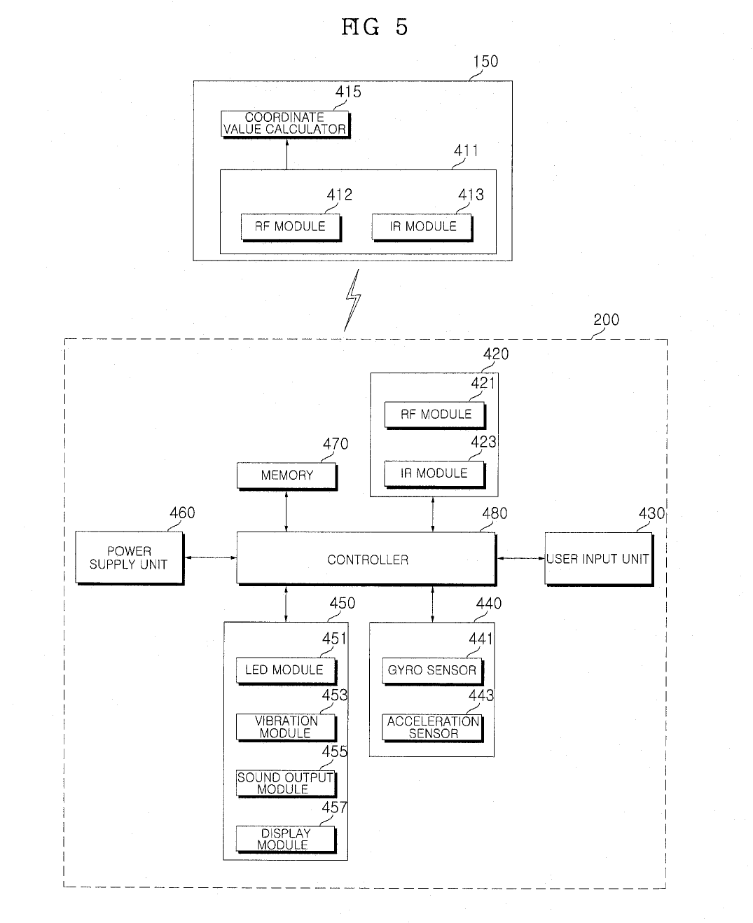

FIG. 5 is an internal block diagram of the remote controller (of FIG. 2).

FIG. 5 shows that a remote controller 200 may include a wireless communication unit 420, a user input unit 430, a sensor unit 440, an output unit 450, a power supply unit 460, a memory 470, and a controller 480.

The wireless communication unit 420 may transmit and receive signals to and from any one of the image display apparatuses according to embodiments. Among the image display apparatuses, the image display apparatus 100 will hereinafter be described by way of example.

In this embodiment, the remote controller 200 may include an RF module 421 to transmit and receive signals to and from the image display apparatus 100 according to an RF communication standard. The remote controller 200 may further include an IR module 423 to transmit and receive signals to and from the image display apparatus 100 according to an IR communication standard.

The remote controller 200 may transmit a signal containing information regarding motion of the remote controller 200 to the image display apparatus 100 through the RF module 421.

The remote controller 200 may receive a signal from the image display apparatus 100 through the RF module 421. The remote controller 200 may transmit a command (such as a power on/off command, a channel switch command) or a volume change command, to the image display apparatus 100 through the IR module 423.

The user input unit 430 may include a keypad, a button, a touchpad, or a touchscreen. The user may input a command related to the image display apparatus 100 to the remote controller 200 by manipulating the user input unit 430. When the user input unit 430 includes a hard key button, the user may input a command related to the image display apparatus 100 to the remote controller 200 by pushing the hard key button. On the other hand, when the user input unit 430 includes a touchscreen, the user may input a command related to the image display apparatus 100 to the remote controller 200 by touching a soft key of the touchscreen. The user input unit 430 may include various kinds of input tools, such as a scroll key and a jog wheel.

The sensor unit 440 may include a gyro sensor 441 or an acceleration sensor 4243. The gyro sensor 441 may sense information regarding motion of the remote controller 200.

For example, the gyro sensor 441 may sense information regarding motion of the remote controller 200 in x, y, and z-axis directions. The acceleration sensor 443 may sense information regarding movement speed of the remote controller 200. The sensor unit 440 may further include a distance sensor to sense the distance between the remote controller 200 and the display 180.

The output unit 450 may output a video or audio signal corresponding to manipulation of the user input unit 430 or a video or audio signal corresponding to a signal received from the image display apparatus 100. The user may recognize whether the user input unit 430 has been manipulated or whether the image display apparatus 100 has been controlled, through the output unit 450.

For example, the output unit 450 may include a light emitting diode (LED) module 451 to be lit, a vibration module 453 to generate vibration, a sound output module 455 to output a sound, or a display module 457 to output an image when the user input unit 430 is manipulated or when a signal is received from or transmitted to the image display apparatus 100 through the wireless communication module 420.

The power supply unit 460 may supply power to the remote controller 200. When the remote controller 200 is not operated for a predetermined time, the power supply unit 460 may interrupt the supply of power to the remote controller 200 in order to reduce power consumption. The power supply unit 460 may resume the supply of power to the remote controller 200 when a predetermined key of the remote controller 200 is manipulated.

The memory 470 may store various types of programs and application data necessary to control or operate the remote controller 200. The remote controller 200 may wirelessly transmit and receive signals to and from the image display apparatus 100 over a predetermined frequency band through the RF module 421. The controller 480 (of the remote controller 200) may store and refer to information regarding a frequency band used for the remote controller 200 to wirelessly transmit and receive signals to and from the paired image display apparatus 100 in the memory 270.

The controller 480 may control overall operation of the remote controller 200. The controller 480 may transmit a signal corresponding to manipulation of a predetermined key of the user input unit 430 or a signal corresponding to motion of the remote controller 200 sensed by the sensor unit 440 to the image display apparatus 100 through the wireless communication unit 420.

The user input interface 150 (of the image display apparatus 100) may include a wireless communication unit 411 to wirelessly transmit and receive signals to and from the remote controller 200 and a coordinate value calculator 415 to calculate a coordinate value of the pointer corresponding to the motion of the remote controller 200.

The user input interface 150 may wirelessly transmit and receive signals to and from the remote controller 200 through an RF module 412. Additionally, the user input interface 150 may receive a signal transmitted from the remote controller 200 according to an IR communication standard through an IR module 413.

The coordinate value calculator 415 may correct a hand tremor or an error from a signal corresponding to motion of the remote controller 200 received through the wireless communication unit 411 to calculate a coordinate value (x, y) of the pointer 205 to be displayed on the display 180.

A signal transmitted from the remote controller 200, which is input to the image display apparatus 100 through the user input interface 150, is transmitted to the controller 170 (of the image display apparatus 100). The controller 170 may differentiate information regarding motion and key manipulation of the remote controller 200 from the signal transmitted from the remote controller 200 and may control the image display apparatus 100 in response to the differentiation.

In another example, the remote controller 200 may calculate a coordinate value of the pointer corresponding to motion of the remote controller 200 and output the calculated coordinate value to the user input interface 150 of the image display apparatus 100. The user input interface 150 (of the image display apparatus 100) may transmit information regarding the received coordinate value of the pointer to the controller 170 without correcting a hand tremor or an error.

In a further example, the coordinate value calculator 415 may not be provided in the user input interface 150 but may be provided in the controller 170.

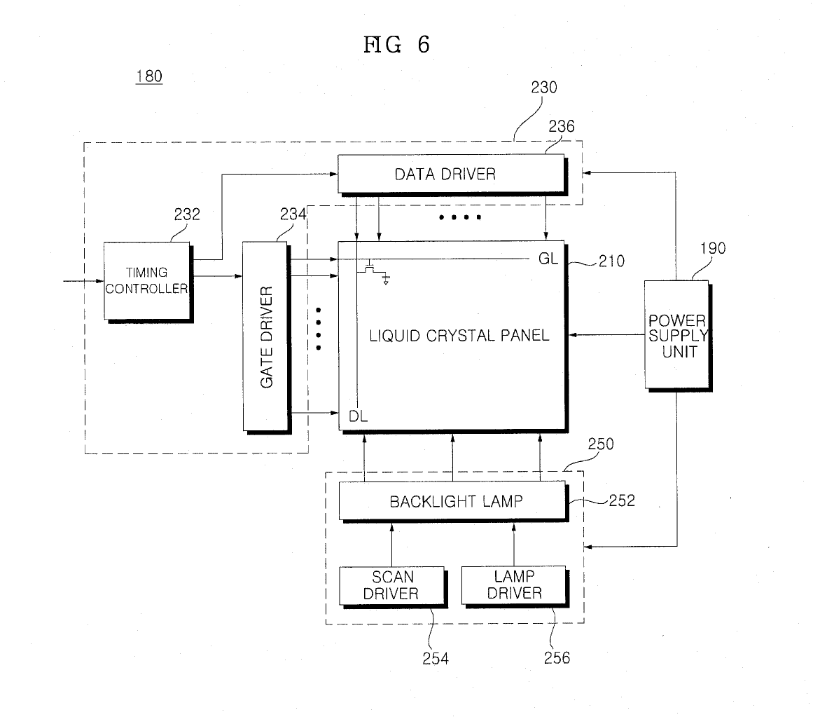

FIG. 6 is a view showing an example of the power supply unit and the interior of the display. Other embodiments and configurations may also be provided.

As shown in FIG. 6, the display 180, which is a display based on a liquid crystal panel (LCD panel), may include a liquid crystal panel 210, a drive circuit unit 230, and a backlight unit 250.

The liquid crystal panel 210 may include a first substrate, a second substrate and a liquid crystal layer. The liquid crystal panel 210 may have a plurality of gate lines GL and data lines DL arranged while intersecting in a matrix form to display an image, a thin film transistor at each intersection, and a pixel electrode connected to the thin film transistor. The second substrate may have common electrodes. The liquid crystal layer may be formed between the first substrate and the second substrate.

The drive circuit unit 230 may drive the liquid crystal panel 210 based on a control signal and a data signal supplied from the controller 170. The drive circuit unit 230 may include a timing controller 232, a gate driver 234, and a data driver 236.

The timing controller 232 may receive a control signal, an RGB data signal, and a vertical synchronization signal Vsync from the controller 170, control the gate driver 234 and the data driver 236 according to the control signal, rearrange the RGB data signal, and provide the rearranged RGB data signal to the data driver 236.

A scan signal and an image signal may be supplied to the liquid crystal panel 210 through the gate lines GL and the data lines DL according to control of the gate driver 234, the data driver 236, and the timing controller 232.

The backlight unit 250 may supply light to the liquid crystal panel 210. The backlight unit 250 may include a plurality of backlight lamps 252 as a light source, a scan driver 254 to control scan driving of the backlight lamps 252, and a lamp driver 256 to turn on/off the backlight lamps 252.

A predetermined image may be displayed using light emitted from the backlight unit 250 in a state in which light transmittance of the liquid crystal panel 210 is adjusted due to an electric field generated between pixel electrodes and common electrodes of the liquid crystal panel 210.

The power supply unit 190 may supply a common electrode voltage Vcom to the liquid crystal panel 210. The power supply unit 190 may supply gamma voltage to the data driver 236. The power supply unit 190 may supply drive power necessary to drive the backlight lamps 252 to the backlight unit 250.

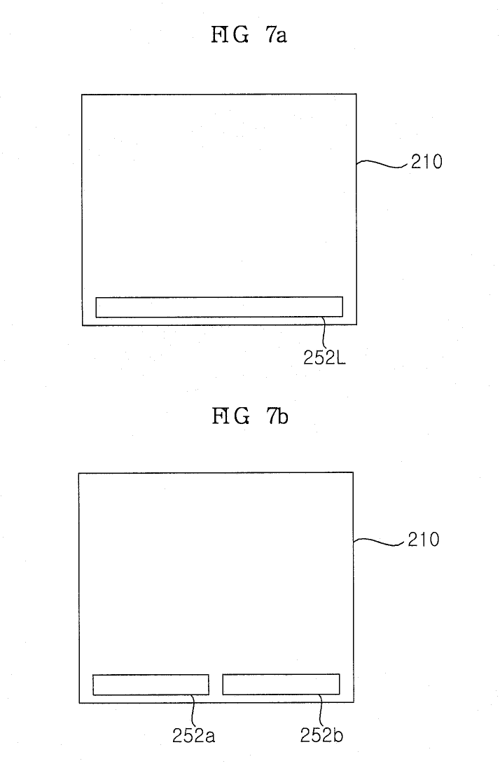

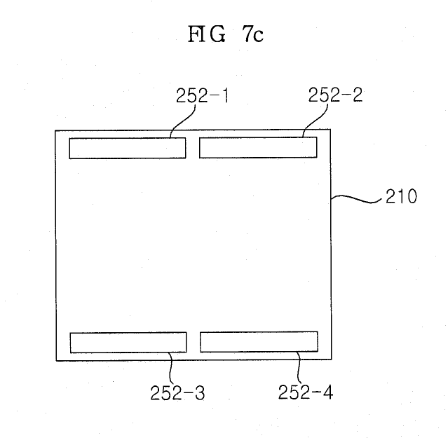

FIGS. 7A to 7C are views illustrating various arrangement examples of backlight lamps. Other embodiments and configurations may also be provided.

FIG. 7A illustrates a bar type backlight lamp 252L disposed at a lower side of a rear of the liquid crystal panel 210. The backlight lamp 252L may include a plurality of light emitting diodes (LEDs). The backlight lamp 252L may emit light to the front of the liquid crystal panel 210 through a diffusion plate to diffuse light, a reflection plate to reflect light, and an optical sheet to polarize, point, and diffuse light.

FIG. 7B illustrates a plurality of bar type backlight lamps 252a and 252b disposed at the lower side of the rear of the liquid crystal panel 210. Each of the backlight lamps 252a and 252b may include a plurality of light emitting diodes (LEDs).

FIG. 7C illustrates a plurality of bar type backlight lamps 252-1, 252-2, 252-3, and 252-4 disposed at upper and lower sides of the rear of the liquid crystal panel 210. Each of the backlight lamps 252-1, 252-2, 252-3, and 252-4 may include a plurality of light emitting diodes (LEDs).

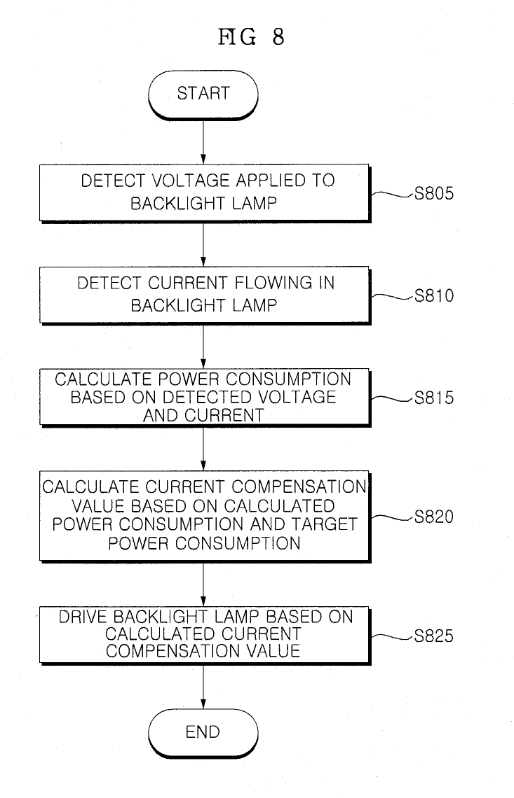

FIG. 8 is a flowchart showing an operation method of an image display apparatus according to an embodiment. Other embodiments and configurations may also be provided.

As shown in FIG. 8, a voltage detection unit DVL (FIG. 11) detects voltage VLED applied to the backlight lamp (S805) and current detection units Dla . . . Dln (FIG. 11) (in the lamp driver 256) detect currents Ifa . . . Ifn flowing in the backlight lamp (S810).

Detected voltage (VLED) data and detected current (Ifa . . . Ifn) data may be input to a drive controller 1120.

The detected current data may be input to a switch driver 1130 (FIG. 11) (in the lamp driver 256). The switch driver 1130 (FIG. 11) may transmit the detected current data Data If to the drive controller 1120. As a result, the drive controller 1120 may receive the detected current data Data If.

Voltage detection and current detection may be repeatedly performed at every predetermined cycle.

Subsequently, the drive controller 1120 (in the lamp driver 256) may calculate (or determine) power consumption based on the detected voltage and the detected current (S815).

The drive controller 1120 may calculate (or determine) the power consumption based on the voltage VLED and the currents Ifa . . . Ifn repeatedly detected at every predetermined cycle. The drive controller 1120 may repeatedly calculate the power consumption at every predetermined period.

Subsequently, the drive controller 1120 (in the lamp driver 256) may calculate (or determine) a current compensation value based on the calculated power consumption and the target power consumption (S820).

The drive controller 1120 may compare the power consumption calculated during a predetermined period with the target power consumption. When the calculated power consumption is higher than the target power consumption, the drive controller 1120 may calculate the current compensation value such that the next calculated power consumption becomes lower than the target power consumption. That is, the drive controller 1120 may calculate the current compensation value such that the current compensation value becomes a negative (−) value.

On the other hand, when the calculated power consumption is lower than the target power consumption, the drive controller 1120 may calculate the current compensation value such that the next calculated power consumption becomes higher than the target power consumption. That is, the drive controller 1120 may calculate the current compensation value such that the current compensation value becomes a positive (+) value.

The drive controller 1120 may transmit a switching control signal Scs to the switch driver 1130. The switching control signal Scs may include information regarding the calculated current compensation value.

When current flowing in the backlight lamp during a first period has a first level, the current compensation value may be calculated such that current flowing in the backlight lamp during a second period (after the first period) has a second level (or is at a second level).

When the power consumption based on the current flowing in the backlight lamp during the first period is higher than the target power consumption, the current compensation value may be calculated such that the second level becomes lower than the first level. On the other hand, when the power consumption based on the current flowing in the backlight lamp during the first period is lower than the target power consumption, the current compensation value may be calculated such that the second level becomes higher than the first level.

Subsequently, the switch driver 1130 (in the lamp driver 256) may drive the backlight lamp based on the calculated current compensation value (S825).

The switch driver 1130 may drive switching devices Sa . . . Sn (FIG. 11) based on the calculated current compensation value.

For example, when the switching devices Sa . . . Sn are controlled based on a pulse width modulation (PWM) mode, turn-on timing may vary in direct proportion to the calculated current compensation value.

As another example, when the switching devices Sa . . . Sn are controlled based on a pulse amplitude modulation (PAM) mode, gate drive voltage may vary in inverse proportion to the calculated current compensation value.

The level of the current flowing in the backlight lamp may be sequentially changed from the first level to the second level during a transition period between the first period and the second period.

When voltage applied to the backlight lamp varies, the current flowing in the backlight lamp may be controlled to follow the target power consumption. As a result, a deviation of power consumption of the backlight lamp may be reduced.

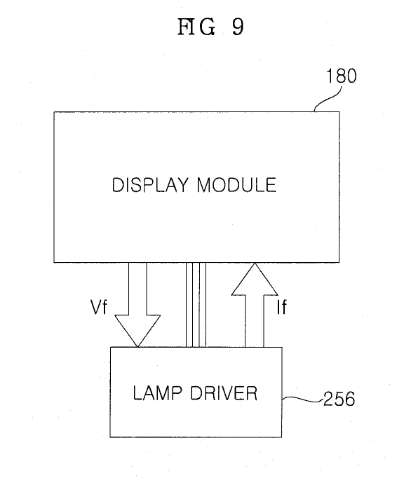

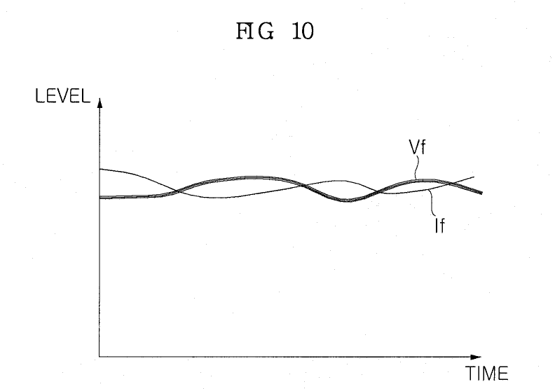

FIGS. 9 and 10 are reference views illustrating an operation method of FIG. 8. Other embodiments and configurations may also be provided.

FIG. 9 illustrates exchange of data between the display module 180 (including the backlight lamp) and the lamp driver 256.

When the backlight lamp includes LEDs, the backlight lamp may emit light by a forward voltage Vf.

When the display module 180 includes the voltage detection unit DVL (FIG. 11), detected voltage VLED corresponding to the Vf voltage is to drive the LEDs. Consequently, input of the detected voltage VLED to the drive controller 1120 as previously described may correspond to transmission of Vf voltage data to the lamp driver 256.

The drive controller 1120 (in the lamp driver 256) may calculate power consumption based on the current (Ifa . . . Ifn) data detected by the current detection units Dla . . . Dln and input voltage (VLED or Vf) data, and the drive controller 1120 may compare the calculated power consumption with the target power consumption to calculate a current compensation value.

The drive controller 1120 may control the currents Ifa . . . Ifn to flow in the backlight lamp based on the calculated current compensation value. This may correspond to transmission of the If current data to the display module 180 performed by the lamp driver 256.

In a method of reducing power consumption and a deviation of the power consumption, Vf voltage or VLED voltage necessary to drive the LEDs may be detected and current If flowing in the backlight lamp may be controlled based on the detected Vf voltage or the detected VLED voltage.

An average level of Vf voltages or VLED voltages detected at every predetermined cycle during the first period may be calculated and a level of the current If flowing in the backlight lamp during the second period (after the first period) may be controlled based on the average level of the Vf voltages or the VLED voltages.

The level of the current If flowing in the backlight lamp may be controlled to follow the target power consumption. For example, power consumption may be calculated (or determined) based on the average level of the Vf voltages or the VLED voltages during the first period, and the calculated power consumption may be compared with the target power consumption to control the current If flowing in the backlight lamp during the second period. More specifically, when the average level of the Vf voltages or the VLED voltages is higher than the target voltage, it may be determined that the calculated power consumption is higher than the target power consumption and the level of the current If flowing in the backlight lamp during the second period may be controlled to be decreased. On the other hand, when the average level of the Vf voltages or the VLED voltages is lower than the target voltage, it may be determined that the calculated power consumption is lower than the target power consumption and the level of the current If flowing in the backlight lamp during the second period may be controlled to be increased.

When the Vf voltage is pulsated (FIG. 10), the current If having a phase difference of about 180 degrees from the Vf voltage flows in the backlight lamp. As a result, it is possible to reduce a deviation of power consumption of the backlight lamp. Additionally, the power consumption may be reduced.

The method of reducing a deviation of the power consumption of the backlight lamp may hereafter be described with reference to FIG. 11 and subsequent drawings.

FIG. 11 is a view showing an example of a partial circuit of an image display apparatus according to an embodiment. Other embodiments and configurations may also be provided.

Referring to FIG. 11, the image display apparatus 100 may include a plurality of backlight lamps Lpa . . . Lpn 1140, the power supply unit 190 to supply power to the backlight lamps Lpa . . . Lpn 1140, and the lamp driver 256 to drive the backlight lamps Lpa . . . Lpn 1140.

Each of the backlight lamps Lpa . . . Lpn may be a string lamp. The string lamp may include a plurality of LEDs connected to each other in series, in parallel, or in series and parallel. As resolution of the image display apparatus 100 may increase to High Definition (HD), Full HD, Ultra High Definition (UHD), 4K, 8K, etc. as previously described, a total number of the LEDs may increase. As a result, drive voltages Vfa . . . Vfn of the string lamps (i.e., the backlight lamps Lpa . . . Lpn) may increase. Otherwise, drive currents Ifa . . . Ifn of the string lamps (i.e., the backlight lamps Lpa . . . Lpn) may be increased. Consequently, power consumption of the backlight lamps may increase due to the increased LED drive voltages Vfa . . . Vfn or currents Ifa . . . Ifn. For this reason, embodiments may provide a method of reducing a deviation of power consumption of backlight lamps while reducing power consumption of the backlight lamps.

The power supply unit 190 may include a DC/DC converter 1110 to convert and output the level of direct current power, an inductor L to remove harmonics, and a capacitor C to store the direct current power. Other components may also be provided.

Voltage at opposite ends of the capacitor C may correspond to voltage supplied between node A and a ground end. This may correspond to voltage applied to the backlight lamps Lpa . . . Lpn 1140. That is, voltage at node A may be referred to as VLED voltage.

The VLED voltage may be divided by resistors R1 and R2, and the divided voltage Vadc may be applied to the drive controller 1120. The drive controller 1120 may operate by the applied voltage Vadc.

The VLED voltage may be partially different from the Vf voltage to operate the backlight lamps. However, the VLED voltage is assumed to be almost equal to the Vf voltage.

On the other hand, the image display apparatus 100 may further include a voltage detection unit DVL to detect the VLED voltage. The voltage detection unit DVL may include a resistor and an amplifier or a voltage transformer VT. The detected VLED voltage may be input to the drive controller 1120. The drive controller 1120 may operate by the applied voltage VLED.

The voltage detection unit DVL may detect the VLED voltage. Since it is assumed that the VLED voltage is almost equal to the Vf voltage as previously described, however, the voltage detection unit DVL may detect voltage applied to the backlight lamps Lpa . . . Lpn.

The lamp driver 256 may include the switching elements Sa . . . Sn to perform switching among the backlight lamps Lpa . . . Lpn 1140, the drive controller 1120 to control driving of the backlight lamps Lpa . . . Lpn 1140, and the switch driver 1130 to control the switching elements Sa . . . Sn based on the switching control signal Scs from the drive controller 1120.

The lamp driver 256 may further include a plurality of resistors Ra . . . Rn connected between the switching elements Sa . . . Sn and a ground end and a plurality of current detection units Dla . . . Dln to detect currents Ifa . . . Ifn flowing in the respective resistors Ra . . . Rn.

Each of the current detection units Dla . . . Dln may include an amplifier or a current transformer CT.

The currents Ifa . . . Ifn detected by the current detection units Dla . . . Dln may be input to the switch driver 1130. The switch driver 1130 may transmit current data Data If based on the detected currents Ifa . . . Ifn to the drive controller 1120.

When an average level of the currents Ifa . . . Ifn flowing in the backlight lamps during the first period is a first level (or at a first level), the drive controller 1120 may control an average level of the currents Ifa . . . Ifn flowing in the backlight lamps during the second period (after the first period) to be a second level (or at a second level).

The drive controller 1120 may calculate (or determine) power consumption based on the voltage VLED applied to the backlight lamps Lpa . . . Lpn and the currents Ifa . . . Ifn flowing in the backlight lamps Lpa . . . Lpn. Additionally, the drive controller 1120 may control the average level of the currents Ifa . . . Ifn flowing in the backlight lamps Lpa . . . Lpn during the second period to be the second level based on the calculated power consumption and the target power consumption. As a result, a deviation of the power consumption of the backlight lamps may be reduced.

More specifically, the drive controller 1120 may calculate (or determine) an average level of the currents Ifa . . . Ifn flowing in the backlight lamps Lpa . . . Lpn during the first period and, when power consumption based on the calculated average level of the currents is higher than the target power consumption, the drive controller 1120 may control the second level of the currents Ifa . . . Ifn flowing in the backlight lamps Lpa . . . Lpn during the second period to become lower than the first level as shown in FIG. 12. As a result, a deviation of the power consumption of the backlight lamps may be reduced. The power consumption may also be reduced.

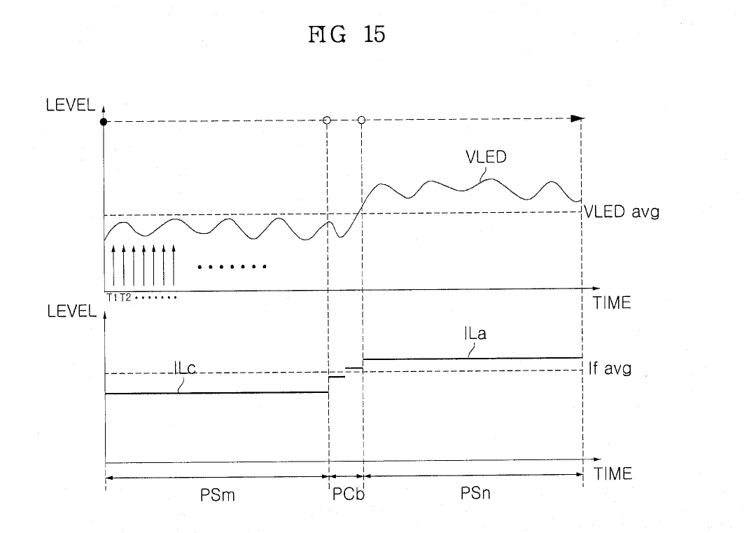

On the other hand, the drive controller 1120 may calculate an average level of the currents Ifa . . . Ifn flowing in the backlight lamps Lpa . . . Lpn during the first period and, when power consumption based on the calculated average level of the currents is lower than the target power consumption, the drive controller 1120 may control the second level of the currents Ifa . . . Ifn flowing in the backlight lamps Lpa Lpn during the second period to become higher than the first level as shown in FIG. 15. As a result, a deviation of the power consumption of the backlight lamps may be reduced. Furthermore, the power consumption may be reduced.

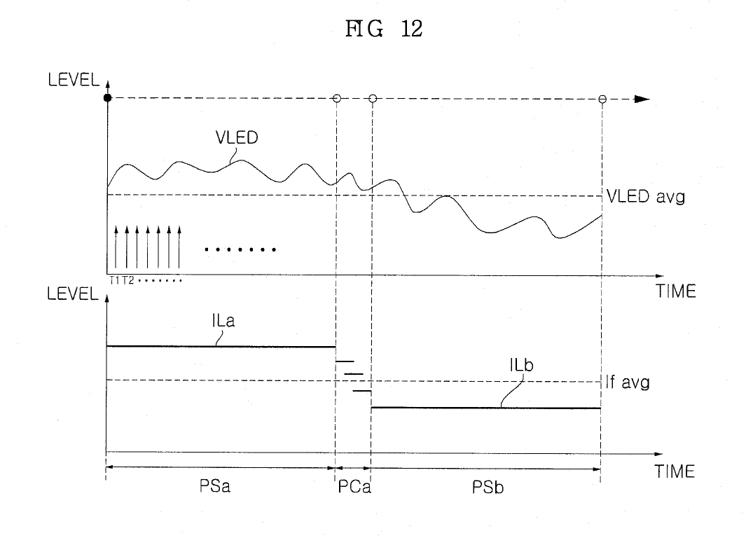

The drive controller 1120 may control the level of the current flowing in the backlight lamp to be sequentially changed from the first level to the second level during a transition period between the first period and the second period as shown in FIG. 13, 14, or 16. That is, the drive controller 1120 may control currents having an intermediate level between the first level and the second level to flow in the backlight lamps Lpa Lpn during the transition period.

On the other hand, the drive controller 1120 may calculate (or determine) a current compensation value to compensate for the currents Ifa . . . Ifn flowing in the backlight lamps Lpa . . . Lpn based on the power consumption calculated based on the currents Ifa . . . Ifn flowing in the backlight lamps Lpa . . . Lpn and the voltages Vfa . . . Vfn applied to the backlight lamps Lpa . . . Lpn and the target power consumption and control the average level of the currents Ifa . . . Ifn flowing in the backlight lamps Lpa . . . Lpn during the second period to be the second level based on the current compensation value. As a result, it is possible to reduce a deviation of the power consumption of the backlight lamps.

When the voltages applied to the backlight lamps Lpa . . . Lpn are changed, the drive controller 1120 may control the currents flowing in the backlight lamps Lpa . . . Lpn to follow the target power consumption.

The drive controller 1120 may calculate (or determine) an average level of the voltages VLED applied to the backlight lamps Lpa . . . Lpn detected at every predetermined cycle during the first period and, when the calculated average level is higher than target voltage VLED avg, the drive controller 120 controls an average level of the currents Ifa . . . Ifn flowing in the backlight lamps Lpa . . . Lpn during the second period (after the first period) to become lower than the average level of the currents Ifa . . . Ifn flowing in the backlight lamps Lpa . . . Lpn during the first period as shown in FIG. 12. As a result, it is possible to reduce a deviation of the power consumption of the backlight lamps. Furthermore, the power consumption may be reduced.

On the other hand, the drive controller 1120 may calculate an average level of the voltages VLED applied to the backlight lamps Lpa . . . Lpn detected at every predetermined cycle during the first period and, when the calculated average level is lower than the target voltage VLED avg, the drive controller 1120 to control an average level of the currents Ifa . . . Ifn flowing in the backlight lamps Lpa . . . Lpn during the second period (after the first period) to become higher than the average level of the currents Ifa . . . Ifn flowing in the backlight lamps Lpa . . . Lpn during the first period as shown in FIG. 15. As a result, a deviation of the power consumption of the backlight lamps may be reduced. Furthermore, the power consumption may be reduced.

FIG. 12 is a view showing an example of voltage and current waveforms applied to backlight lamps according to an embodiment. Other embodiments and configurations may also be provided.

FIG. 12 illustrates voltages VLED applied to the backlight lamps Lpa . . . Lpn during a first period PSa or an average level of the applied voltages VLED is higher than target voltage VLED avg and, therefore, the levels of currents Ifa . . . Ifn flowing in the backlight lamps Lpa . . . Lpn or an average level of the currents Ifa . . . Ifn is a first level ILa, which is higher than target current If avg.

The drive controller 1120 may calculate (or determine) power consumption of the backlight lamps based on voltages VLED and currents Ifa . . . Ifn sequentially (T1, T2 . . . ) detected at every predetermined cycle during the first period PSa and compare the calculated power consumption with the target power consumption.

When the calculated power consumption is higher than the target power consumption, the drive controller 1120 may control current having a second level ILb lower than the first level ILa to flow in the backlight lamps Lpa . . . Lpn during a second period PSb.

The drive controller 1120 may calculate (or determine) a current compensation value based on the sequentially detected voltages VLED and currents Ifa . . . Ifn and control currents flowing in the backlight lamps Lpa . . . Lpn during a transition period PCa between the first period PSa and the second period PSb such that the levels of the currents are sequentially decreased from the first level ILa to the second level ILb based on the calculated current compensation value.

The voltages VLED detected during the second period PSb are decreased. As a result, the calculated power consumption higher than the target power consumption during the first period PSa is decreased during the second period PSb. As the power consumption is controlled during the transition period PCa (as described above), the power consumption of the backlight lamps follows the target power consumption. A deviation of the power consumption may be reduced and overall power consumption may be reduced.

According to the method of reducing the power consumption, a deviation of the power consumption may be reduced per period. When the resolution of the image display apparatus 100 is increased and, therefore, the voltages Vf applied to the backlight lamps or the currents If flowing in the backlight lamps are increased, it is possible to more effectively reduce power consumption. That is, although the resolution of the image display apparatus 100 is increased, a deviation of the power consumption may be reduced and power consumption may be reduced.

The target power consumption may vary based on an image pattern. For example, an image pattern corresponding to full white may be displayed on the display panel and the target power consumption may be set when luminance of the backlight unit is the highest in response to the image pattern.

On the other hand, the drive controller 1120 may calculate a current compensation value when the voltages VLED sequentially (T1, T2 . . . ) detected at every predetermined cycle during the first period PSa are lower than the target voltage and control the currents flowing in the backlight lamps Lpa . . . Lpn during the transition period PCa between the first period PSa and the second period PSb such that the levels of the currents are sequentially decreased from the first level ILa to the second level ILb based on the calculated current compensation value.

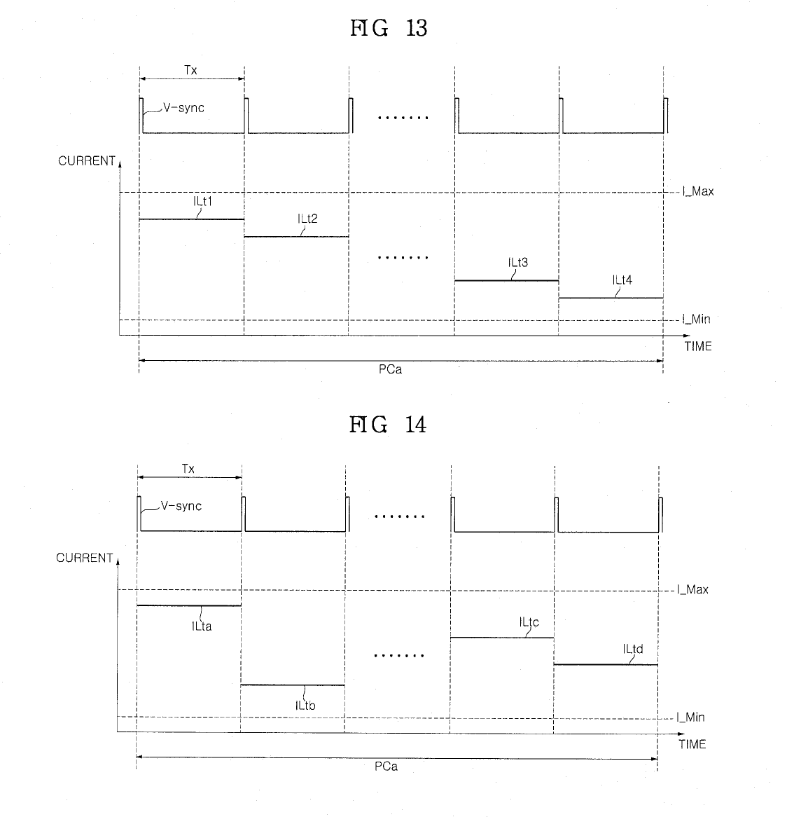

FIGS. 13 and 14 are views showing various examples of the transition period of FIG. 12, which is partially enlarged. Other embodiments and configurations may also be provided.

FIG. 13 illustrates that the levels are sequentially decreased from the first level ILa to the second level ILb during the transition period Pca (FIG. 12). At this time, a level decrease cycle may correspond to a cycle Tx corresponding to vertical resolution Vsync for image display.

FIG. 13 illustrates that the levels are decreased between the first level ILa and the second level ILb in order of ILt1, ILt2 . . . ILt3, and ILt4.

The drive controller 1120 may control the levels to be sequentially decreased during the transition period Pca, as shown in FIG. 13. At this time, the level decrease cycle may correspond to the cycle Tx corresponding to the vertical resolution Vsync for image display.

FIG. 14 illustrates that the levels are stepwise decreased from the first level ILa to the second level ILb during the transition period Pca (FIG. 12).

FIG. 14 illustrates that the levels are not sequentially decreased but are decreased while pulsating (unlike FIG. 12). That is, FIG. 14 illustrates that the levels are decreased between the first level ILa and the second level ILb in order of ILta, ILtb . . . ILtc, and ILtd. At this time, ILtb may be lower than ILtc.

The drive controller 1120 may control the levels to be stepwise decreased in sine wave form during the transition period Pca, as shown in FIG. 14.

FIG. 15 is a view showing an example of voltage and current waveforms applied to backlight lamps according to an embodiment. Other embodiments and configurations may also be provided.

FIG. 15 illustrates that voltages VLED applied to the backlight lamps Lpa Lpn during a first period PSm or an average level of the applied voltages VLED is lower than target voltage VLED avg and, therefore, the levels of currents Ifa . . . Ifn flowing in the backlight lamps Lpa . . . Lpn or an average level of the currents Ifa . . . Ifn is a third level ILc, which is lower than target current If avg.

The drive controller 1120 may calculate (or determine) power consumption of the backlight lamps based on voltages VLED and currents Ifa . . . Ifn sequentially (T1, T2 . . . ) detected at every predetermined cycle during the first period PSm and compare the calculated power consumption with target power consumption. When the calculated power consumption is lower than the target power consumption, the drive controller 1120 may control currents having a first level ILa higher than the third level ILc to flow in the backlight lamps Lpa . . . Lpn during a second period PSn.

The drive controller 1120 may calculate (or determine) a current compensation value based on the voltages VLED and the currents Ifa . . . Ifn sequentially (T1, T2 . . . ) detected at every predetermined cycle during the first period PSm and control currents flowing in the backlight lamps Lpa . . . Lpn during a transition period PCb between the first period PSm and the second period PSn such that the levels of the currents are sequentially decreased from the third level ILc to the first level ILa based on the calculated current compensation value.

The voltages VLED detected during the second period PSn may be increased as shown in the drawing. As a result, the calculated power consumption lower than the target power consumption during the first period PSm may be increased during the second period PSn. As the power consumption is controlled during the transition period PCb (as described above), the power consumption of the backlight lamps follows the target power consumption. A deviation of the power consumption may be reduced and overall power consumption may be reduced.

On the other hand, the drive controller 1120 may calculate a current compensation value when the sequentially detected voltages VLED are lower than the target voltage and control the currents flowing in the backlight lamps Lpa . . . Lpn during the transition period PCb between the first period PSm and the second period PSn such that the levels of the currents are sequentially increased from the third level ILc to the first level ILa based on the calculated current compensation value.

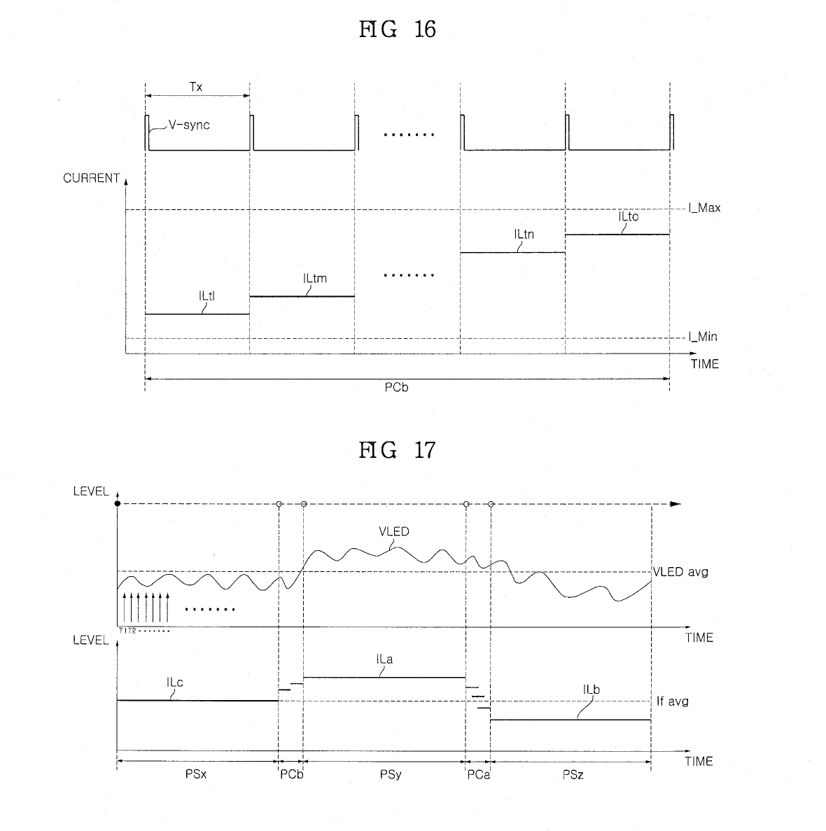

FIG. 16 is a view showing an example of the transition period of FIG. 15, which is partially enlarged. Other embodiments and configurations may also be provided.

FIG. 16 illustrates that the levels are sequentially increased from the third level ILc to the first level ILa during the transition period Pcb (FIG. 15). At this time, a level increase cycle may correspond to a cycle Tx corresponding to vertical resolution Vsync for image display.

FIG. 16 illustrates that the levels are increased between the third level ILc and the first level ILa in order of ILtl, ILtm . . . ILtn, and ILto.

The drive controller 1120 may control the levels to be sequentially decreased during the transition period Pca, as shown in FIG. 16. At this time, the level increase cycle may correspond to the cycle Tx corresponding to the vertical resolution Vsync for image display.

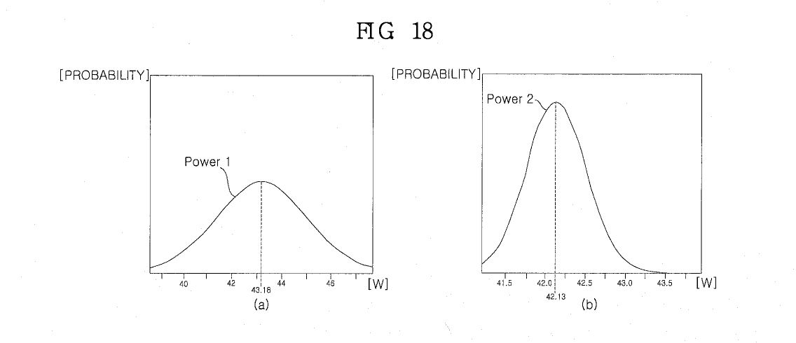

FIG. 17 is a view showing an example of voltage and current waveforms applied to backlight lamps according to an embodiment. Other embodiments and configurations may also be provided.

The waveform diagram of FIG. 17 is a combination of the waveform diagram of FIG. 15 and the waveform diagram of FIG. 12. FIG. 17 illustrates that voltages VLED sequentially (T1, T2 . . . ) detected at every predetermined cycle during a first period PSx or an average level of the applied voltages VLED is lower than target voltage and the levels of currents flowing in the backlight lamps Lpa . . . Lpn is a third level ILc.

As power control, levels of currents flowing in the backlight lamps Lpa . . . Lpn during the transition period PCb are sequentially increased from the third level ILc to the first level ILa and, as a result, the detected voltages LVED become higher than the target voltage and the levels of current flowing in the backlight lamps Lpa . . . Lpn become the first level ILa during a second period PSy.

Since the detected voltages LVED are higher than the target voltage and the levels of currents flowing in the backlight lamps Lpa . . . Lpn are the first level ILa during the second period PSy, the levels of current flowing in the backlight lamps Lpa Lpn during the transition period PCa are sequentially decreased from the first level ILa to the second level ILb and, as a result, the detected voltages VLED become lower than the target voltage and the levels of current flowing in the backlight lamps Lpa . . . Lpn become the second level ILb during a third period PSz.

FIG. 18 is a graph showing distribution of power consumption.

FIG. 18(a) illustrates a first probability distribution curve (Power 1) of power consumption when the method of reducing the deviation of the power consumption as described above is not used for a 47 inch image display apparatus. On the other hand, FIG. 18(b) illustrates a second probability distribution curve (Power 2) of power consumption when the method of reducing the deviation of the power consumption as described above is used for the 47 inch image display apparatus.

Referring to FIG. 18, average power consumption based on the first probability distribution curve (Power 1) is about 43.18 W and average power consumption based on the second probability distribution curve (Power 2) is about 42.13 W.

The average power consumptions are similar to each other. However, it can be seen that the power consumption when the method of reducing the deviation of the power consumption is used is slightly lower than the power consumption when the method of reducing the deviation of the power consumption is not used.

Additionally, it can be seen that a standard deviation of the power consumption is considerably improved in a case of the second probability distribution curve (Power 2). That is, it can be seen that the standard deviation of the power consumption based on the second probability distribution curve (Power 2) is lower than the standard deviation of the power consumption based on the first probability distribution curve (Power 1). It may be possible to reduce a deviation of power consumption of the backlight lamp and to reduce a deviation of power consumption of the image display apparatus 100.

The operation method of the image display apparatus may be realized as code, which is readable by a processor included in the image display apparatus, in recording media readable by the processor. The recording media readable by the processor may include all kinds of recording devices to store data, which are readable by the processor. Examples of the recording media readable by the processor may include a read only memory (ROM), a random access memory (RAM), a compact disc read only memory (CD-ROM), a magnetic tape, a floppy disk, and an optical data storage device. Additionally, the recording media readable by the processor may also be realized in the form of a carrier wave, such as transmission through the Internet. Further, the recording media readable by the processor may be distributed to computer systems connected to each other through a network such that a code readable by the processor is stored or executed in a distribution mode.

As is apparent from the above description, according to the embodiments, when levels of currents flowing in the backlight lamp during a first period are a first level, the image display apparatus controls the levels of currents flowing in the backlight lamps during a second period (after the first period) to be a second level. Consequently, it is possible to reduce a deviation of power consumption. Additionally, it is possible to reduce power consumption.

The image display apparatus may control actual power consumption to follow target power consumption. It may be possible to reduce a deviation of power consumption of the image display apparatus, particularly a display apparatus having a panel.

According to the method of reducing the power consumption as described above, a deviation of the power consumption may be reduced per period. When the resolution of the image display apparatus is increased and, therefore, voltages applied to the backlight lamps or currents flowing in the backlight lamps are increased, the power consumption may be effectively reduced. That is, although resolution of the image display apparatus is increased, it is possible to stably reduce a deviation of the power consumption and to stably reduce power consumption.

Although the preferred embodiments have been disclosed for illustrative purposes, those skilled in the art will appreciate that various modifications, additions and substitutions are possible, without departing from the scope and spirit of the invention as disclosed in the accompanying claims.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An image display apparatus comprising:
a panel;
a backlight lamp to provide light to the panel; and
a drive controller to control current flowing at the backlight lamp during a first period and a second period, the second period being after the first period,
wherein when the current flowing at the backlight lamp during the first period is at a first level, the drive controller controls the current flowing at the backlight lamp during the second period to be at a second level.

2. The image display apparatus according to claim 1, wherein the drive controller determines power consumption based on voltage applied to the backlight lamp and the current flowing at the backlight lamp during the first period, and the drive controller controls the current flowing at the backlight lamp during the second period to be at the second level based on the determined power consumption and a target power consumption.

3. The image display apparatus according to claim 2, wherein, when the power consumption based on the current flowing at the backlight lamp during the first period is determined to be higher than the target power consumption, the drive controller controls the second level to be lower than the first level.

4. The image display apparatus according to claim 2, wherein, when the power consumption based on the current flowing in the backlight lamp during the first period is determined to be lower than the target power consumption, the drive controller controls the second level to be higher than the first level.

5. The image display apparatus according to claim 2, wherein the drive controller controls the current flowing in the backlight lamp to be sequentially changed from the first level to the second level during a transition period between the first period and the second period.

6. The image display apparatus according to claim 2, wherein the first level and the second level are average values of the current flowing in the backlight lamp.

7. The image display apparatus according to claim 2, wherein the drive controller determines a current compensation value based on the determined power consumption and the target power consumption during the first period, and the drive controller controls the current flowing at the backlight lamp during the second period to be the second level based on the determined current compensation value.

8. The image display apparatus according to claim 2, wherein the target power consumption is power consumption corresponding to an image having a specific pattern displayed on the panel.

9. The image display apparatus according to claim 1, further comprising:
a switching element to drive the backlight lamp;
a voltage detection unit to detect voltage applied to the backlight lamp;
a current detection unit to detect current flowing at the backlight lamp; and
a switch driver to drive the switching element.

10. The image display apparatus according to claim 9, wherein the switch driver to provide current data detected by the current detection unit to the drive controller, and the switch driver to receive, from the drive controller, a switching control signal to control the current flowing at the backlight lamp.

11. The image display apparatus according to claim 9, wherein the drive controller determines power consumption based on voltage data detected by the voltage detection unit and current data detected by the current detection unit, and the drive controller controls the current flowing at the backlight lamp during the second period to be at the second level based on the determined power consumption and a target power consumption.

12. The image display apparatus according to claim 1, wherein when voltage applied to the backlight lamp changes, the drive controller controls the current flowing at the backlight lamp to correspond to the target power consumption.

13. An image display apparatus comprising:
a panel;
a backlight lamp to provide light to the panel; and
a drive controller to control current flowing at the backlight lamp during at least a first period and a second period, the second period being after the first period, wherein the drive controller to change at least one characteristic of current flowing at the backlight lamp during the second period, wherein
the drive controller controls current flowing at the backlight lamp during the second period based on an average level of voltage applied to the backlight lamp during the first period.

14. The image display apparatus according to claim 13, wherein when the average level of the voltage applied to the backlight lamp during the first period is determined to be lower than a target voltage, the drive controller controls the current flowing at the backlight lamp during the second period to be higher than the current flowing at the backlight lamp during the first period.

15. The image display apparatus according to claim 14, wherein when the voltage applied to the backlight lamp during the second period is determined to be higher than the target voltage, the drive controller controls the current flowing at the backlight lamp during a third period to be a lower level than the current flowing at the backlight lamp during the second period.

16. The image display apparatus according to claim 13, wherein the drive controller controls the current flowing at the backlight lamp during a transition period between the first period and the second period to be sequentially changed from the first level to the second level.

17. An operation method of an image display apparatus comprising:
detecting voltage applied to a backlight lamp;
detecting current flowing at the backlight lamp;
determining power consumption based on the detected voltage and the detected current;
determining a current compensation value based on the determined power consumption and a target power consumption; and
driving the backlight lamp based on the determined current compensation value.

18. The operation method according to claim 17, wherein determining the current compensation value includes determining the current compensation value such that when the current flowing at the backlight lamp during a first period is determined to be at a first level, the drive controller controls the current flowing at the backlight lamp during a second period to be at a second level, wherein the second period is after the first period.

19. The operation method according to claim 17, wherein determining the current compensation value includes:
determining the current compensation value such that when power consumption based on the current flowing at the backlight lamp during the first period is determined to be higher than a target power consumption, the second level is lower than the first level; and
determining the current compensation value such that when the power consumption based on the current flowing at the backlight lamp during the first period is determined to be lower than the target power consumption, the second level is higher than the first level.

20. The operation method according to claim 18, further comprising sequentially changing the current flowing at the backlight lamp from the first level to the second level during a transition period between the first period and the second period.

21. The image display apparatus according to claim 1, wherein the drive controller to determine at least one characteristic of current flowing at the backlight lamp during the first period and to change at least one characteristic of current flowing at the backlight lamp during the second period.
